(19) United States
(12) Patent Application Publication
(10) Pub. No.: US 2004/0128480 A1
(43) Pub. Date: Jul. 1, 2004

(54) Register file read port to support uop fusion

(75) Inventors: Ittai Anati, Haifa (IL); Zeev Sperber, Zichron Yaakov (IL)

Correspondence Address: B. Delano Jordan, c/o Blakely, Sokoloff, Taylor & Zafman LLP, 12400 Wilshire Boulevard, Seventh Floor, Los Angeles, CA, 90025, US

(73) Assignee: INTEL CORPORATION

(21) Appl. No.: 10/331,345

(22) Filed: Dec. 31, 2002

(51) Int. Cl. G06F 9/30

(52) U.S. Cl. 712/214; 712/216

(57) ABSTRACT

A system and method of allocating register file read ports provides for mapping different-sized register file read ports to a plurality of micro-operation (uop) source fields. One approach involves mapping a first read port of a register file to a first uop source field for a particular read cycle. A second read port is mapped to a second uop source field for the read cycle, where the first and second read ports have a first size. A third read port is mapped to a third uop source field for the read cycle, where the third read port has a second size. Mapping the third read port accommodates for the use of fused uops, which have data relating to multiple operations. Furthermore, the second size can be less than the first size in order to minimize the impact on die area and circuit speed paths.

### CROSS REFERENCE TO RELATED APPLICATIONS

The present application is related to U.S. patent application Ser. No. 10/217,033 entitled “Fusion of Processor of Micro-Operations” filed by Simcha Gouchman et al. on Aug. 13, 2002.

### BACKGROUND

1. Technical Field

Embodiments of the present invention generally relate to computer processors. More particularly, embodiments relate to accessing a register file in an architecture that uses fused micro-operations.

2. Discussion

Computers have become an integral part of modem society, and the demand for more functionality, lower costs and greater efficiency continues to grow. In order for computers to continue to meet the needs of the marketplace, a number of software as well as hardware issues must be addressed. For example, compiling programs into low-level macro-instructions, decoding the macro-instructions into even lower level micro-operations (uops), dispatching uops to an execution core, storing write back data to a register file as register data and mapping read ports of the register file to source fields of subsequent uops are but a small sampling of the processes that must be considered when improving computer efficiency.

A conventional uop has traditionally had one operational code (opcode) field and two source fields. The opcode field specifies the operation to be performed and the source fields provide the data to be used in the operation. When the data required by the source fields of a particular uop is ready, the uop can be dispatched to an execution core for execution. A portion of a traditional processor architecture is shown in FIG. 1 at 10, wherein a reservation station (RS) 12 dispatches uops to an execution core (not shown) and write back data is sent to a register file 14 of a reorder buffer (ROB) 16 based on execution of the uops. The write back data may also come from other locations such as cache memory, off-chip memory, other pipeline stages, etc., and is used as a source for subsequent uops. The illustrated architecture 10 is similar to the Pentium®Pro Pentium®II or Pentium®III micro-architecture available from Intel Corporation, Santa Clara, Calif.

Before a uop can be dispatched to the execution core, the source fields of the uop (or “sources”) must be “valid”, which means the data required for the source fields must be ready for reading from the registers in register file 14. Each uop can use data from two source registers in the register file 14. Data size may vary according to the type of operation. For example, an integer operation requires 8, 16 or 32 bits, while a multimedia instruction such as an MMX® technology instruction requires 64 bits. In order for at least one uop to be able to be issued into the out-of-order (OOO, discussed below) machine in a given cycle, the register file 14 has two read ports, where each read port can read data for one valid source and write it into a source field. Each of these read ports support the maximum data size format so that all types of uops are able to be dispatched.

Since the traditional reservation station 12 is able to process three uops (i.e., uop0, uop1, uop2) simultaneously, a “worst” case scenario involves six sources being required in any given read cycle. The use of two read ports in the case of non-fused uops has not been a problem, however, because uops are often dependent upon one another and it is most likely that while processing a certain uop, the sources for that uop are not yet ready. Therefore, in many cases two ports are enough. Indeed, traditional architectures use a technique commonly referred to as “out-of-order” (OOO) execution, in which uops are executed when all of the necessary dependencies are resolved (and the execution resources are available) instead of the order in which they are encountered. The ROB 16 therefore maps the two read ports of the register file 14 to the two uop source fields that require data that is ready in the register file 14 when the uops are issued.

In order to minimize further the performance penalty due to the potential shortage in read ports, the ROB 16 uses a register folding network 18. If a register in the register file 14 contains data for a given uop source field, the register folding network 18 is able to determine whether any of the other five source fields also require the data read from the register file 14 (i.e., both sources require the same register). If so, the register folding network 18 “folds” the register data into the additional uop source fields as necessary so that the read port and associated register are shared between multiple uop source fields. Thus, one read port can serve multiple source fields if they use the same register.

While the above-described approach has been acceptable under certain circumstances, it has been determined that when inherently serial operations are encountered, processing efficiency can be improved through the use of “fused” uops. A fused uop uses a third source field to enable the uop to capture data regarding multiple operations. While one approach to accommodating fused uops would be to add a maximum sized read port to the register file 14, various difficulties such as reduced area, slower circuit speed paths and more validation effort can arise. There is therefore a need to allocate register file read ports in a manner that can sufficiently support fused uops, without the inherent shortcomings associated with adding a full-sized read port to the register file.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a conventional microprocessor architecture that has a register file with two read ports;

FIG. 2 is a flowchart of an example of a method of allocating register file read ports according to one embodiment of the invention;

FIG. 3 is a block diagram of a microprocessor architecture according to one embodiment of the invention;

FIG. 4 is a diagram of an example of a port allocation framework according to one embodiment of the invention;

FIG. 5 is a diagram of an example of a port allocation framework according to an alternative embodiment of the invention; and

FIG. 6 is a block diagram of an example of a computer system according to one embodiment of the invention.

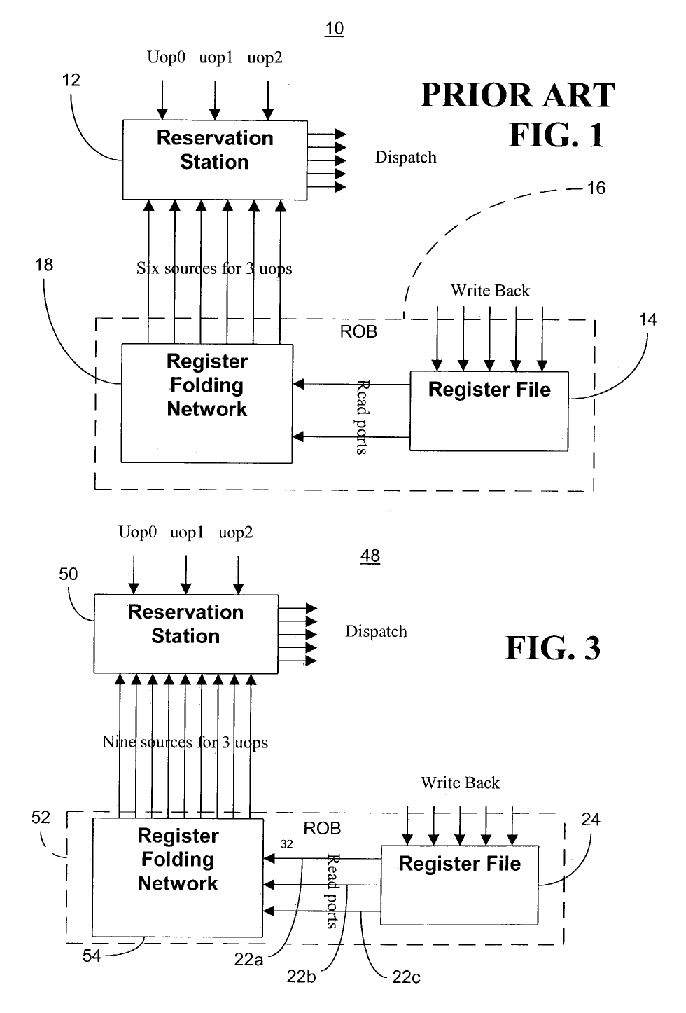

### DETAILED DESCRIPTION

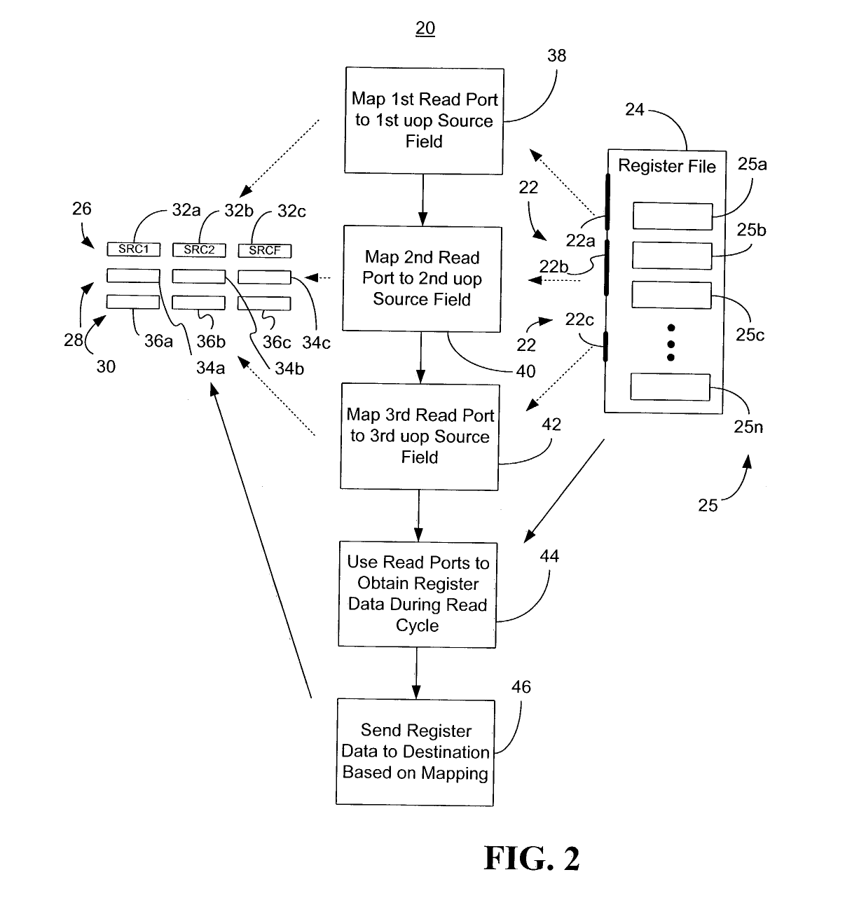

Turning now to FIG. 2, a method 20 of allocating different-sized register file read ports is shown. Method 20 can be implemented in a reorder buffer (ROB) as a set of instructions capable of being executed by a processor to allocate read ports 22 (22a-22c) of a register file 24 among one or more micro-operation (uop) source fields, where each uop 26, 28, 30 can have three source fields (32a-32c, 34a-34c, 36a-36c). The instructions can be written using any number of well-known software programming techniques and can be stored in a wide variety of machine-readable media such as electronically erasable programmable read only memory (EEPROM), compact disk ROM (CD-ROM), dynamic random access memory (DRAM), etc.

Processing block 38 provides for mapping a first read port 22a of the register file 24 to a first uop source field for a particular read cycle. Register file 24 has a plurality of general purpose registers 25 (25a-25n), where the number of registers may vary depending upon the circumstances. For example, one architecture uses eight general purpose registers. A second read port 22b of the register file 24 is mapped to a second uop source field for the read cycle at block 40, where the first and second read ports 22a, 22b have a first size. In one approach, the first size is 64 bits in order to accommodate the most complex of instructions such as multimedia instructions. Block 42 provides for mapping a third read port 22c of the register file 24 to a third uop source field for the read cycle, where the third read port 22c has a second size. The read ports 22a-22c therefore have at least two different sizes. The read ports 22a-22c may be mapped to uop source fields that are associated with a common uop, distributed across a pair of uops or each associated with a different uop. As will be discussed in greater detail below, the assignment of read ports can be in accordance with a predetermined priority order that can be defined in a number of different ways. Thus, processing blocks 38, 40 and 42 can be implemented in a different order than the order shown without parting from the spirit and scope of the embodiments of the invention.

The size of the third read port (i.e., the second size) is generally less than the size of the other two read ports (i.e., the first size), and in one approach is 32 bits to accommodate address calculation data such as an address index, which incorporates a scaling factor. Address calculation data also generally includes an address base and an address displacement. One approach to specifying memory addresses is discussed in U.S. Pat. No. 5,860,154 to Abramson et al., although other approaches may be used.

To better illustrate the use of a smaller read port, the structure of a fused uop will now be described in greater detail. Although fused uop 26 will be selected and specific port sizes will be used to facilitate discussion, the discussion applies to any of the fused uops 26, 28, 30 and any size of read port. Generally, when a macro-instruction is decoded into a fused uop, data relating to a first operation is transferred from the macro-instruction to the fused uop 26 and data relating to a second operation is also transferred from the macro-operation to the fused uop 26. In transferring the data relating to the first operation, 32-bit address base data is written to a first region of a first source field 32a (SRC1, base). In addition, 32-bit address displacement data is written to a second region of the first source field 32a (SRC1, displacement), where the address displacement data results from a constant immediate value and does not require a register file read port. Furthermore, 64-bit or 32-bit data is written to a second source field 32b (SRC2) and 32-bit address index data is written to a third source field 32c (SRCF, index), where traditional non-fused uops generally do not contain the third source field 32c. Thus, the first source field 32a receives 32 bits of data from the register file read port when used for address calculation data, and the third source field 32c receives 32 bits of data. It is important to note that the first source field 32a may receive 64-bit data when not used for fused sources. As in the case of the first source field 32a, the second source field 32b can receive up to 64 bits of data. In addition, a first operational code (opcode) is written to a first opcode field (not shown) of the fused uop 26. In transferring the data relating to the second operation, a second opcode is written to a second opcode field (not shown) of the fused uop 26 and a second operand is written to the second source field 32b.

Thus, source fields 32c, 34c and 36c are not required to receive more than 32 bits of data because address index data is limited to 32 bits. The third read port 22c can therefore have a size (e.g., bit width) that is less than the size of the other read ports 22a, 22b without sacrificing performance. In fact, the use of a smaller read port enables difficulties regarding area, speed and validation to be obviated. Processing block 44 provides for using read ports 22a-22c to obtain register data from the register file 24 during the read cycle. The register data is sent to its destination at block 46 based on the mapping illustrated in blocks 38, 40 and 42. The destination may be the reservation station (RS) or the execution core, depending upon the architecture being used.

FIG. 3 shows an architecture 48 that includes a reservation station 50 and a reorder buffer (ROB) 52. The reservation station 50 dispatches uop data to the execution core (not shown) and the ROB 52 has a register file 24 with three read ports 22a, 22b, 22c as discussed above. Furthermore, the illustrated third read port 22c is dedicated to uop source fields requiring address calculation data such as address index data.

Although the illustrated architecture shows the ROB 52 as sending register data for the source fields to the RS 50, the embodiments of the present invention are not so limited. For example, the ROB 52 may also bypass the RS 50 and send the register data directly to the execution core. Such an architecture is used in the Pentium®4 style processor available from Intel Corporation, Santa Clara, Calif.

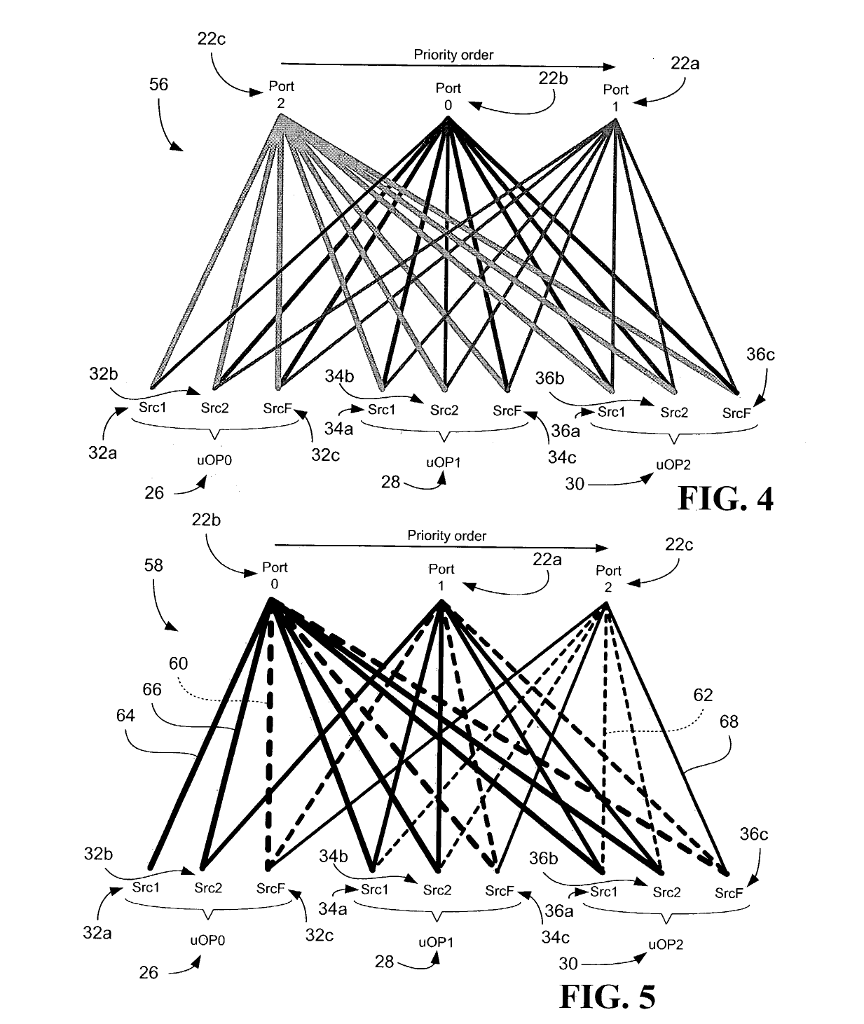

Notwithstanding, ROB 52 further includes a register folding network 54 coupled to the register file 24 and the reservation station 50. The term “coupled” is used herein to describe any type of connection, direct or indirect, that enables information to be passed between components. Examples of such a connection include, but are not limited to electrical connection, optical connection, magnetic connection, radio frequency connection, physical connection and any combination thereof. The register folding network 54 is able to fold one or more of the read ports 22a-22c into additional uop source fields in order to minimize the performance penalty due to any shortage in read ports. FIGS. 4 and 5 show alternative approaches to mapping and folding in greater detail.

Turning now to FIG. 4, allocation framework 56 shows a relatively aggressive implementation that attempts to take advantage of the third read port 22c (“Port 2”) as much as possible. The third read port 22c is assigned the highest allocation priority order in the illustrated example. Since the third read port 22c has a reduced size, it is matched with a source field requiring data of the same width or less. Thus, the wider read ports are left for later allocation. As a consequence, the third read port 22c can potentially deliver data to any one of the source fields 32a-32c, 34a-34c, 36a-36c. In addition, non-fused uops (i.e., uops with only two source fields) may make use of the third read port 22c even though they do not have a third source field.

In FIG. 5, allocation framework 58 shows an alternative implementation that simplifies the requirements for the third read port 22c. Specifically, the third read port 22c is assigned the lowest priority relative to the other read ports 22a, 22b. Furthermore, the third read port 22c is reserved for the third source field 32c, 34c, 36c of each uop 26, 28, 30, respectively. The dotted lines therefore indicate cases in which the given read port can only be folded into the source field in question. For example, relationship 60 illustrates that full-sized read port 22b can only be folded into source field 32c and relationship 62 illustrates that smaller read port 22c can only be folded into source field 36a. On the other hand, relationships 64 and 66 demonstrate that full-sized read port 22b can be mapped directly to source fields 32a and 32b, and relationship 68 demonstrates that smaller read port 22c can be mapped directly to source field 36c. Such an approach simplifies the allocation logic and the register folding network. Under the approach shown in framework 58, however, non-fused uops can only benefit from the additional port in the case of folding. Simply put, one of the other uops must be a fused uop that has a third source field receiving data that can be shared in order for a non-fused uop to benefit. Thus, if all three uops are non-fused uops, the conventional worst-case scenario of six sources for two read ports is maintained. On the other hand, if any of the other uops are fused, significant benefits can be achieved. If the first uop is fused and the third port is used to read from a 32-bit register, then that read port can be folded to any 32-bit source needed by the other two uops.

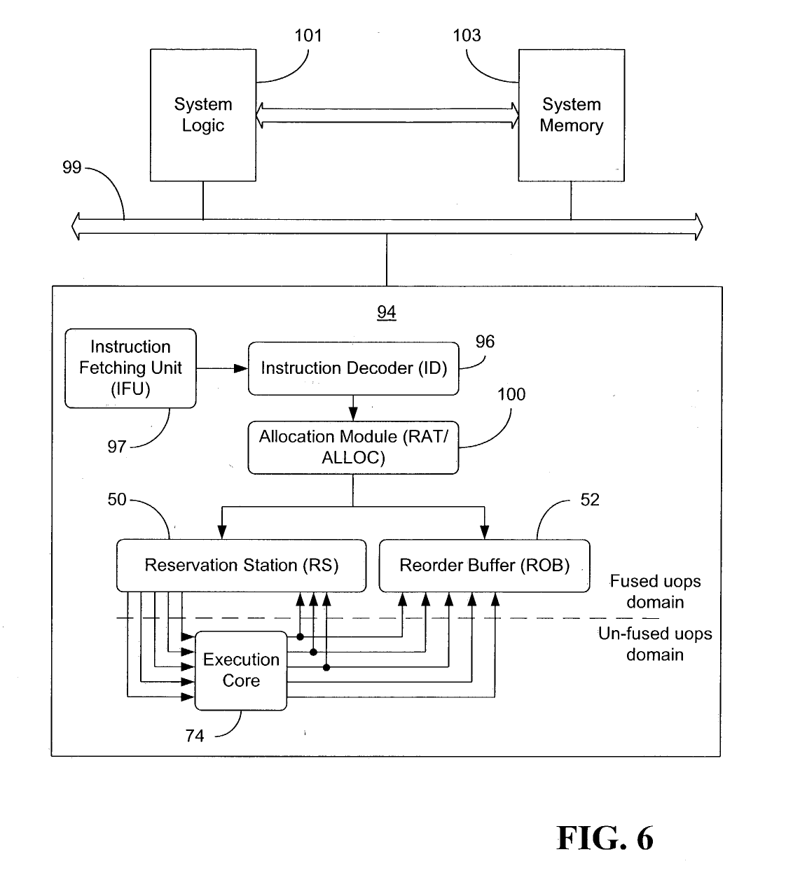

FIG. 6 shows an architecture including a microprocessor 94 that can be used to implement the approaches discussed above. Generally, a first stage of an instruction fetching unit (IFU) 97 performs a read of the instruction cache (not shown) or may read from a processor bus 99, which may communicate with system logic 101 and/or system memory 103 according to well-documented approaches. The data read is passed on to a second stage of the IFU 97—the instruction length decoder. The instruction length decoder marks the beginning and end of each instruction and passes data on to two places. The first destination is the branch target buffer (BTB, not shown), where a target address lookup is performed. If a valid target is found, a new IFU address is presented to the first stage and the new code is fetched. The second destination is the third stage of the IFU 97. The third stage is the instruction rotation stage, where instructions are rotated to align exactly with their respective decoder units.

In addition, the microprocessor 94 has an execution core 74, an instruction decoder 96 (ID), and a reservation station 50 (RS). The ID 96 has two simple decoders and one complex decoder, and generates one or more fused uops based on the macro-instruction obtained from the IFU 97. It is important to note that the fused uops enable the ID 96 to decode more instructions per clock cycle. The reservation station 50 dispatches uop data to the execution core 74. It can be seen that upon dispatch, the uops are un-fused and are sent to the appropriate execution unit within the execution core 74. The illustrated execution core 74 can operate in accordance with the well-documented Intel® P6 architecture and may have two ports that occupy floating point units (FPU), two integer units, and several FP and non-FP single instruction/multiple data (SEMD) execution units (EUs), two ports that occupy two address generation units (AGUs) for load/store operations, and one port for the store data. Thus, the execution core 74 can be viewed as having five input ports and five output ports. To simplify processing, all entries of the reservation station 50 are identical and can hold any type of uop. Dispatching is determined by checking the validity of the operation sources and determining whether an execution unit for this type of operation is available. The data received from ports 0, 1 and 2 (EU ports and the memory load data port) is written into any RS entries that are dependent on them.

It can further be seen that an allocation module 100 is disposed between the ID 96 and the RS 50. The allocation module 100 assigns physical registers to the uops based on a register alias table (RAT). As already discussed, the ROB 52, stores write back data such as the results of the second operations and the exception/fault information of both operations. By combining two uops into one during the front-end and out-of-order (or RS) stages of the uop, the machine is effectively widened. The front-end appears to be wider because more instructions are able to pass through. The out-of-order stage appears to be wider because the same array size now holds more instructions. The retirement stages are wider because more instructions are able to retire in a clock cycle. The execution core 74, however, is unaffected by the fusion. This is accomplished by “un-fusing” the fused uops and separately dispatching the operations to the appropriate execution unit(s). The results are merged back together in the ROB 52 by using a single register entry.

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method of allocating register file read ports, comprising:
mapping different-sized register file read ports to a plurality of micro-operation (uop) source fields.

2. The method of claim 1 further including:
mapping a first read port of a register file to a first uop source field for a particular read cycle;
mapping a second read port of the register file to a second uop source field for the read cycle, the first and second read ports having a first size; and
mapping a third read port of the register file to a third uop source field for the read cycle, the third read port having a second size.

3. The method of claim 2 wherein the second size is less than the first size.

4. The method of claim 3 further including mapping the read ports based on a predetermined priority order, the third read port being dedicated to uop source fields requiring address calculation data.

5. The method of claim 4 wherein the priority order defines the third read port as having a highest priority relative to the first and second read ports.

6. The method of claim 4 wherein the priority order defines the third read port as having a lowest priority relative to the first and second read ports.

7. The method of claim 4 further including folding at least one of the read ports into an additional uop source field based on the predetermined priority order.

8. The method of claim 2 wherein the uop source fields are associated with a common uop.

9. The method of claim 2 wherein the uop source fields are distributed across a pair of uops.

10. The method of claim 2 wherein each uop source field is associated with a different uop.

11. The method of claim 2 further including:
using the read ports to obtain register data from the register file during the read cycle; and
sending the register data to a reservation station based on the mapping.

12. The method of claim 2 further including:
using the read ports to obtain register data from the register file during the read cycle; and
sending the register data to an execution core based on the mapping.

13. A method of allocating register file read ports, comprising:
mapping a first read port of a register file to a first micro-operation (uop) source field for a particular read cycle based on a predetermined priority order;
mapping a second read port of the register file to a second uop source field for the read cycle based on the priority order, the first and second read ports having a first size;
mapping a third read port of the register file to a third uop source field for the read cycle based on the priority order, the third read port having a second size which is less than the first size and being dedicated to uop source fields requiring address calculation data;
folding at least one of the read ports into an additional uop source field based on the priority order;
using the read ports to obtain register data from the register file; and
sending the register data to a reservation station based on the mapping and the folding.

14. The method of claim 13 wherein the priority order defines the third read port as having a highest priority relative to the first and second read ports.

15. The method of claim 13 wherein the priority order defines the third read port as having a lowest priority relative to the first and second read ports.

16. The method of claim 13 wherein the first, second and third uop source fields are associated with a common uop.

17. The method of claim 13 wherein the first, second and third uop source fields are distributed across a pair of uops.

18. The method of claim 13 wherein each of the first, second and third uops is associated with a different uop.

19. A processor comprising:
an execution core;
a reservation station coupled to the execution core; and
a reorder buffer coupled to the execution core and the reservation station, the reorder buffer having a register file with different-sized read ports.

20. The processor of claim 19 wherein the read ports include:
a first read port having a first size;
a second read port having the first size; and
a third read port having a second size, the second size being less than the first size.

21. The processor of claim 20 wherein the third read port is dedicated to micro-operation (uop) source fields requiring address calculation data.

22. The processor of claim 19 wherein the reader buffer is to map a first read port of the register file to a first uop source field for the read cycle, map a second read port of the register file to a second uop source field for the read cycle, and map a third read port of the register file to a third uop source field for the read cycle, the third read port having a size which is less than a size of the first and second read ports.

23. The processor of claim 22 wherein the reorder buffer maps the read ports based on a predetermined priority order.

24. The processor of claim 19 further including a register folding network coupled to the register file and the reservation station, the register folding network to fold at least one of the read ports into an additional uop source field based on a predetermined priority order.

25. The processor of claim 19 wherein the reservation station is to dispatch micro-operation (uop) data to the execution core, the execution core to send register data to write ports of the register file based on execution of the uop data.

26. A system comprising:
a processor bus coupled to a system memory; and
a processor coupled to the bus, the processor to generate micro-operations (uops) based on macro-instructions received from the system memory, the processor including an execution core, a reservation station coupled to the execution core, and a reorder buffer coupled to the execution core and the reservation station, the reorder buffer having a register file with different-sized read ports.

27. The system of claim 26 wherein the read ports include:
a first read port having a first size;
a second read port having the first size; and
a third read port having a second size, the second size being less than the first size.

28. The system of claim 27 wherein the third read port is dedicated to uops requiring address calculation data.

29. The system of claim 26 further including a register folding network coupled to the register file and the reservation station, the register folding network to fold at least one of the read ports into an additional uop source field based on a predetermined priority order.
